(19) United States
(12) Patent Application Publication
(10) Pub. No.: US 2023/0371561 A1
(43) Pub. Date: Nov. 23, 2023

(54) FOOD PRODUCTS COMPRISING FUNGAL MYCELIUM, PROCESS FOR THEIR PREPARATION AND USES THEREOF

(71) Applicants: YISSUM RESEARCH DEVELOPMENT COMPANY OF THE HEBREW UNIVERSITY OF JERUSALEM, Jerusalem (IL); KINOKO - TECH LTD., Jerusalem (IL)

(72) Inventor: Daria FELDMAN, Rehovot (IL)

(21) Appl. No.: 18/006,594

(22) PCT Filed: Oct. 27, 2021
(86) PCT No.: PCT/IL2021/051270

§ 371 Date: Jan. 24, 2023

(30) Foreign Application Priority Data
Oct. 28, 2020 (IL) 278364
Apr. 18, 2021 (IL) 282374

(51) Int. Cl. A23L 11/50; A23L 31/00; A23L 7/10

(52) U.S. Cl. CPC A23L 11/50; A23L 31/00; A23L 7/197

(57) ABSTRACT

The present disclosure provides a composite material comprising fungal mycelium and plant seeds, said fungal mycelium is of a non-toxic fungus, and is in a form of a filamentous mass occupying spaces between neighboring seeds, the seeds being essentially fixed in place and essentially evenly distributed within the mass wherein said composite material is visco-elastic, characterized by a delta (δ) angle of between 8 and 20 when determined using an oscillation test at 25° C., and a complex shear strain of at least 0.6% and frequency of 1.00 Hz. Also provided by the present disclosure is a process for obtaining the composite material, the process comprises incubating fungal mycelium, from at least one non-toxic fungus, on a substrate comprising water saturated plant seeds, said incubation comprises solid-state fermentation (SSF) conditions, wherein said incubation of the plant seeds is at a density of less than about 0.3 gr/cm3 and for at least 55 hours. The composite material can be a food product or can be a food ingredient.

### TECHNOLOGICAL FIELD

The present disclosure resides in the food industry and specifically in fungi-based food product.

### BACKGROUND ART

References considered to be relevant as background to the presently disclosed subject matter are listed below:
U.S. Pat. No. 6,569,475
US Patent Application Publication No. 20140065263
Kathleen A. Hachmeister & Daniel Y. C. Fung “Tempeh: A Mold-Modified Indigenous Fermented Food Made from Soybeans and/or Cereal Grains” Critical Review in Microbiology 19(3):137-188 (1993)
Erkan, S. B., Gürler, et al. “Production and Characterization of Tempehs from Different Sources of Legume” Rhizopus oligosporus, LWT—Food Science and Technology 119: 108880(2020).
Fan L. Pandey et al. “Use of Various Coffee Industry Residues for the Cultivation of Pleurotus ostreatus in Solid State Fermentation” Acta Biotechnol. 20(1):41-52 (2000)
US Patent Application Publication No. 2019/0373934
Octavio Paredes-Lopez et al. “Influence of Solid Substrate Fermentation on the Chemical Composition of Chickpea” Journal of Fermentation and Bioengineering 71(1):58-62 (1991)
Tri Handoyo & Naofumi Morita “Structural and Functional Properties of Fermented Soybean (Tempeh) by Using Rhizopus oligosporus” International Journal of Food Properties, 9(2): 347-355 (2006).
European Patent Application No. 2835058
U.S. Pat. No. 4,367,240
US Patent Application Publication No. 2004/014660
US Patent Application Publication No. 2009/0148558
Globes (https://www.globes.co.il/news/article.aspx?did=100126964) by Jasmin Ravid

Acknowledgement of the above references herein is not to be inferred as meaning that these are in any way relevant to the patentability of the presently disclosed subject matter.

### BACKGROUND

The global demand and consumers of plant-based alternative proteins are on the rise in the last decade. The growth is not only in consumers that identify themselves as vegan or vegetarians, but those now referred to as flexitarians reducing meat consumption from ecological, ideological, or health reasons. The global market of alternative proteins worth 18.5B$ and estimated to grow up to 40.6B$ by 2025.

U.S. Pat. No. 6,569,475 describes a method for culturing mushroom mycelia using grains, a culture product, and use of the culture product. Edible or medicinal mushroom mycelia are inoculated and cultured in solid media made of grains. Induction of the cultured mushroom mycelia to undergo autolysis produces autolysates rich in antitumorigenic and other medicinally useful materials. The squeezing of the autolysates produces a liquid filtrate, leaving a paste. The filtrate is concentrated for use in foods or medicines. The paste is processed into a nutrient-rich gruel or other foods.

US Patent Application Publication No. 20140065263 describes a method comprising inoculating an agricultural substrate with one or more species of pure fungal culture comprising Basidiomycota and Ascomycota derived from liquid state fermentation, enabling mycelial growth on the agricultural substrate by controlling growth conditions and harvesting of a myelinated agricultural product after the mycelial growth reaches a desired stage. The method is described as providing functional foods with health benefits.

The use of fermented soybean as a source for plant-based alternative proteins was also described, inter alia, by Kathleen A. Hachmeister & Daniel Y. C. Fung (1993), Erkan, S. B., Gürler, et al (2019), Tri Handoyo & Naofumi Morita (2006) and US 2004/014660. Such products are recognized by its traditional name Tempeh.

Fan L. Pandey et al. (2000) describes studies carried out to evaluate the feasibility of using coffee industry residues, viz. coffee husk, coffee leaves and spent coffee ground as substrates in solid state fermentation (SSF) to cultivate edible mushrooms Pleurotus. Octavio Paredes-Lopez et al. (1991) describes a procedure to produce a fermented product by solid substrate fermentation using Rhizopus oligosporus and chickpea as substrate.

US 2019/0373934 describes a method of growing fungal mycelium and forming edible food products includes growing fungal cells in a growth media such that the fungal cells produce mycelium. The growth media includes a sugar, a nitrogen-containing compound, and a phosphate-containing compound. The mycelium is separated from the growth media.

EP 2835058 describes a method for the production of a meat substitute composition based on solid state fermentation, wherein the method comprises the steps of: (i) providing a substrate having a moisture content of above 50% (w/w) comprising two different ingredients each having a different texture; (ii) introducing to said substrate an edible mushroom mycelium; and (iii) allowing said mycelium to grow in said substrate for a period which is sufficient to saturate the substrate with mycelium to provide the meat substitute composition.

U.S. Pat. No. 4,367,240 describes a process for the preparation of a textured protein-containing material in which an amylolytic fungus is grown on a moist starch-based substrate which includes a nitrogen source assimilable by the fungus the substrate being provided in the form of small, partially gelatinized particles. During growth, the fungus degrades and utilizes a large proportion of the starch, resulting in a dense matrix of closely interwoven mycelia, randomly dispersed with substances containing the residual starch or starch degradation products.

US 2009/0148558 describes a method of producing mushroom mycelia-based meat analog, a meat analog produced using the method, low-calorie synthetic meat, and a meat flavor comprising the meat analog. The meat analog can be produced from mushroom mycelia within a short period of time in a cost and effort effective manner.

Lately, Jasmin Ravid describes the growing of mycelium on edible material, such as legume or grains, the product being protein rich.

### GENERAL DESCRIPTION

The present disclosure is based on the development of a unique edible solid composite material that is rich in protein, have good rheological and organoleptic properties that allows it to be used as a protein replacer for various foods such as burgers, sausages, and hybrid product. The product aroma varies from odorless to mild fungal to strong mushroom depends on fermentation period.

Thus, in accordance with a first aspect, the present disclosure provides a composite material comprising fungal mycelium and plant seeds, said fungal mycelium is of a non-toxic fungus, and is in a form of a filamentous mass occupying spaces between neighboring seeds, the seeds being essentially fixed in place and essentially evenly distributed within the mass, wherein said composite is visco-elastic, characterized by a delta (δ) angle of between 8 and 20 when determined using an oscillation test at 25° C., and a complex shear strain of at least 0.6%. and angular frequency of 1.0 Hz.

Also provided by the present disclosure is a process for obtaining an edible composite material, the process comprises incubating fungal mycelium, from at least one non-toxic fungus, on a substrate comprising water saturated plant seeds, said incubation comprises solid-state fermentation (SSF) conditions, wherein said incubation of the plant seeds is at a density of less than about 0.3 gr/cm³ and for at least 55 hours.

Yet, the present disclosure provides a food product comprising the composite material disclosed herein and at least one externally added food ingredient. As such, the composite material disclosed herein, being non-toxic and preferably edible, is suitable for use as a food ingredient.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A-1C are photographic images of an edible composite comprising F. proliferatum mycelium and lentils, after 7 days of SSF, from top view (FIG. 1A), side view (FIG. 1B) and cross-sectional view (FIG. 1C).

FIG. 2 is a microscope image of the hyphal network of the mycelium, viewed by magnification of *100, Bar=400 Standard microscopy was performed with an EVOS FL Auto Cell Imaging System (Life Technologies).

FIG. 3 is a graph presenting Young's modulus of elasticity of green lentils or lentils with rice (25%) with and without SSF by F. proliferatum.

FIG. 4 presents the average (n=4) of rheometric results of Soy-SSF and Tempeh-soya. The pattern corresponds to viscos-elastic solids.

FIGS. 5A-5B are microscope images showing the hypha of an exemplary edible composite of a type disclosed herein, under white light (FIG. 5A), and after Calcofluor-white staining using florescence microscopy (FIG. 5B) magnification of *200, Bar=200 Standard and confocal microscopy were performed with an EVOS FL Auto Cell Imaging System (Life Technologies).

FIGS. 6A-6B are images of lentils grown for 7 days in an environment having low levels of moisture (about 10%). The images show lack of sufficient growth (FIG. 6A) with only minimal mycelial growth (FIG. 6B—where the arrow is pointing on mycelium).

FIGS. 7A-7B are images of an exemplary edible composite grown for 7 days in an environment having high levels of moisture (about 85%). The images present formation of significant amounts of aerial hyphae at the top end of the composite (FIG. 7A), and low amounts of hypha at the bottom end of the composite (FIG. 7B).

FIGS. 8A-8B are images of an exemplary edible composite grown for 7 days, after excessive aeration (i.e. low CO₂ concentration), showing high content of aerial hypha at the top end of the composite (FIG. 8A) and low amounts of hypha at the bottom end of the composite (FIG. 8B).

FIGS. 9A-9C are cross sectional images of an exemplary edible composite (FIG. 9A) and of Tempeh based on black turtle bean (FIG. 9B) or Tempeh based on soya beans (FIG. 9C), with the black arrows point to the mycelium and white arrows to the seeds' material.

### DETAILED DESCRIPTION

The present disclosure is based on the development of an edible solid and visco-elastic mass that is rich in fungal mycelium and plant seeds material. Also disclosed herein is a process for producing the edible composite material (solid mass) and food products comprising the same.

The edible composite material disclosed herein offers a nutritional solution for those seeking a healthy, tasty, and vegan product having high quality nutritional values and high protein to carbohydrates ratio.

In a first of its aspects, the disclosure provides the composite material (in a form of a visco-elastic mass) comprising fungal mycelium and plant seeds, wherein the fungal mycelium is in a form of a filamentous mass cross sectioning the composite material and having the seeds essentially fixed in place and distributed within the mass, wherein the composite material is characterized by a delta (6) angle of between 8 and 20 when determined using an oscillation test at 25° C., and a complex shear strain of at least 0.6% and angular frequency of 1.0 Hz.

An unexpected finding of the present disclosure is the ability to grow mycelium on seeds for a long period of time, without the formation of contaminations this being contrary to the teaching of Tempeh where it is necessary to avoid long incubation periods (typically up to 48 hours). Further, the production of Tempeh requires pressing the seeds to prevent formation of air pockets that could support growth of contaminations, this also being contrary to the process disclosed herein (density of seeds for incubation period being equal or less than 0.3 gr/cm³).

The composite material disclosed herein was feasible, inter alia, by the selection of fungus having a slow growing rate as further discussed below, the seeds' relatively low density at incubation starting point and, at times, the low/controlled level of aeration.

The composite material disclosed herein is non-toxic and preferably edible composite material. In the context of the present disclosure, when referring to “edible composite material” it is to be understood to encompass a filamentous fungus mass from a non-toxic and preferably an edible fungus (one or more fungi) holding a plurality of seeds spread within the fungal mycelial mass and with the seeds being easily identified within the mycelial mass.

The term “fungal mycelium” is used to denote the vegetative part of the fungus. Preferably, the fungal mycelium employed is one being free of the fruiting body. Further, in the context of the present disclosure, the fungal mycelium can encompass mycelia material from a single fungus species; yet in some other examples, the fungal mycelium comprises a combination of mycelia material from two or more different fungi. The fungal mycelium within the composite disclosed herein has a filamentous appearance, which is the result of being mainly composed of the branching, thread-like hyphae matter of the mycelium. Preferably, the fungal mycelium forms a matrix/scaffold that holds, essentially fixed in place, the seeds distributed within the scaffold, such that said filamentous mass occupying spaces between the seeds.

As noted above, the fungal mycelium is at least a non-toxic fungus.

In the context of the present disclosure, it is to be understood that when referring to “non-toxic” it includes all fungus material that is recognized as being at least non-toxic to animals, particularly humans. In one example, the non-toxic fungus is one that is recognized by those versed in the art as an edible fungus, even if when at the time of filing it was only categorized as non-toxic.

In some examples, the non-toxic fungal mycelium is of an edible fungus.

In the context of the present disclosure, it is to be understood that when referring to “edible” it includes all fungus material that is acceptable in the art as being safe for animals, and particularly for human consumption, hence not producing toxic compounds such as mycotoxins.

In some examples, the fungus is one that has a growing rate that provides a bulk density of less than 1 gr/cm³, when said fungus mycelium is incubated for a period of at least three days at a temperature of about 26° C., with water saturated and autoclaved plant seeds placed on a growing container at a seeds density of less than 0.3 gr/cm³.

In some examples, the mycelium is from a non-toxic fungus belonging to the ascomycota division of fungi.

In some other examples, the mycelium is from an edible fungus belonging to the basidiomycota division of fungi.

Ascomycota and Basidiomycota form the sub-kingdom Dikarya and are filamentous fungi composed of hyphae and reproduce sexually.

In some examples, the Ascomycota species is Fusarium spp.

A non-limiting list of fungi that belong to the Fusarium spp includes the strains of Fusarium venenatum, F. proliferatum, and Fusarium yellowstonensis.

In some preferred examples, the fungus is any strain of F. proliferatum.

In some examples, the Ascomycota species is Aspergillus oryzae, Aspergillus Sojae, Aspergillus luchuensis, Neurospora intermedia.

In some examples, the mycelium is or comprises at least mycelium of the Fusarium spp. and particularly it is or comprises at least F. proliferatum.

In some other examples, the mycelium is from a fungal mycelium belonging to the Agaricomycetes class of fungi.

Non-toxic and preferably edible fungi from the Agaricomycetes class can be of any genus selected from agaricus, amanita, armillaria, auricularia, boletus, Bovista, calbovista, calvatia, cantharellus, chlorophyllum, clitocybe, clitopilus, coprinus, cortinarius, craterellus, entoloma, flammulina, gomphus, grifola, polypilus, Gyromitra, helvella, hericium, hydnum, hygrophorus, lactarius, leccinum, lentinus, lepiota, chlorophyllum, lepiota, lepiota, clitocybe, lycoperdon, marasmius, morchella, phlogiotis, pholiota, pleurocybella, pleurotus, pluteus, polypilus, grifola, polyozellus, polyporus, ramaria, rozites, russula, sparassis, strobilomyces, stropharia, suillus, terfezia, tremella, tricholoma, tuber, volvariella.

In some examples, the mycelium is from a fungus selected from the Pleurotus genus and the Lentinula genus.

In some examples, the mycelium is from one or a combination of fungi selected from Lentinula edodes, Pleurotus pulmunarius and Pleurotus ostreatus.

In some examples, the mycelium is or comprises at least mycelium of the Pleurotus pulmunarius species.

In the context of the present disclosure, the mycelium is not of Rhizopus oligosporus, of the Zygomycota division (e.g. from which Tempeh is made). In other words, the edible composite material of the present disclosure is not Tempeh and is not and/or cannot be produced by the process by which Tempeh is produced.

In this connection, it is noted that R. oligosporus propagation involves a-sexual spores and have a growth rate that is much faster than that of the non-toxic fungi employed by the present disclosure. Inoculation of a mold type fungi and specifically R. oligosporus with seeds, e.g. soybean results in the formation of a mycelium over the beans in less than 55 hours, or even less than 48 hours, which while may be mistakenly considered to have a similar appearance, is significantly different in terms of texture, aroma, taste and/or mouthfeel, as will be further discussed below. Without being bound thereto, it is believed that the lower density as compared to Tempeh and the viscoelastic properties of the composite material of the present disclosure improves at least the mouthfeel and/or texture of the product.

Yet further, the inoculation of R. oligosporus requires a closed/sealed environment (typically entrapped in banana leaf or in plastic bags with a limited access of oxygen provided by small holes), thus under high CO₂ levels with no or very low oxygen levels, growth period of 30-48 hr, and incubation temperature above 30° C.

The resulting products, such as Tempeh, have organoleptic properties, such as texture and biochemical properties (e.g. metabolites) that are significantly different from that of the composite material of the present disclosure. As noted above, the edible composite material of the present disclosure has a more “mushroom” texture due to the greater growth of mycelium within the core of the product, providing it with a texture and mouthfeel that is extremely different from that of Tempeh.

Thus, the use of R. oligosporus is explicitly excluded from the scope of the present disclosure.

The composite material comprises seeds. The “seeds” or “seeds material”, in the context of the present disclosure, refer to any type of edible plant embryonic material. This includes, inter alia, cereal grains, legumes, and nuts. In some examples, the seeds material comprises at least legumes.

A non-limiting list of legumes that can be part of the edible composite and process disclosed herein include, kidney bean, navy bean, pinto bean, black turtle bean, haricot bean (Phaseolus vulgaris), lima bean, butter bean (phaseolus lunatus), adzuki bean, azuki bean (Vigna angularis), mung bean, golden gram, green gram (Vigna radiata), black gram, urad (Vigna mungo), scarlet runner bean (Phaseolus coccineus), ricebean (Vigna umbellata), moth bean (Vigna aconitifolia), tepary bean (Phaseolus acutifolius), dry broad beans (Vicia faba), horse bean (Vicia faba equina), broad bean (Vicia faba), field bean (Vicia faba), dry peas (pisum spp.), garden pea (Pisum sativum var. sativum), protein pea (Pisum sativum var. arvense), chickpea, garbanzo, bengal gram (Cicer arietinum), dry cowpea, black-eyed pea, blackeye bean (Vigna unguiculata), pigeon pea, arhar/toor, cajan pea, congo bean, gandules (Cajanus cajan), lentil (Lens culinaris), bambara groundnut, earth pea (Vigna subterranea), vetch, common vetch (Vicia sativa), lupins (lupinus spp.), pulses NES, minor pulses, lablab, hyacinth bean (Lablab purpureus), jack bean (Canavalia ensiformis), sword bean (Canavalia gladiata), winged bean (Psophocarpus tetragonolobus), velvet bean, cowitch (Mucuna pruriens var. utilis), yam bean (Pachyrhizus erosus).

In some examples, the seeds material comprises grains. In yet some further examples, the seeds material comprises cereal grains, including pseudocereal grains.

Without being limited thereto, the grain can be any member of the group consisting of finger millet, fonio, foxtail millet, Japanese millet, coix lacryma-jobi var. ma-yuen, kodo millet, maize (corn), millet, pearl millet, proso millet, sorghum, barley, oats, rice, rye, wild rice, wheat, triticale, teff, spelt, amaranth (amaranth family), buckwheat (smartweed family), kiwicha, kaniwa, quinoa (amaranth family, goosefoot family), chia (mint family), soybeans, runner beans, pigeon peas, peanuts, mung beans, lupins, lima beans, lentils, fava beans, common peas (garden peas), common beans and chickpeas.

In some examples, the seeds consist of legume.

In some examples, the seeds comprise a combination of two types of seeds.

In some examples, the seeds material comprises a combination of at least one type of legume and at least one type of grain.

In some examples, the seeds are not soybeans.

When the seeds material comprises a combination of legume and grain, the ratio therebetween may be dependent on the type of grain used and the desired end result in terms of texture, taste etc., and yet, in some examples, the ratio can be any legume to grain ratio selected from 1:1, 1:2, 1:4, or any ratio between 1:1 and 1:10.

The unique SSF process disclosed herein enables the formation of a dense mycelium around, above and below the seeds in a way that the seeds are essentially enveloped by the mycelium and fixed in place within the mycelium mass, without the formation or presence of a fruiting body. This has shown to provide the composite material with its unique visco-elastic properties.

Visco-elastic behavior can be defined by evaluating changes in Elastic (or Storage) Modulus, G′; Viscous (or Loss) Modulus, G″; and phase angle, δ, over a limited frequency range. From these changes it is possible to determine whether a material is likely to have a yield stress or a zero-shear viscosity and also potential stability issues.

The phase angle, δ, and elastic modulus, G′, are general indicators of structural characteristics. Thus, the magnitude and direction of change with decreasing frequency can indicate the nature of the material response at longer times.

Generally, if G′ is largely independent of frequency and the phase angle remains either constant or decreases with reducing frequency, then one can infer the material to be more likely to maintain network structure and it will be more stable.

Yet, if the phase angle, δ, increases and G′ decreases with decreasing frequency then this would indicate that the elastic elements of the structure (the network) are relaxing and becoming liquid-like, thus, likely to infer lower stability of the material.

Further, generally, a phase angle δ can be between 0°, for matter exhibiting an ideally visco-elastic behavior and 90°, for matter exhibiting an ideally viscous behavior. Any angle in between this range provides a measurable and characteristic physical property of the analyzed matter.

The G′, G″ and phase and phase angle can be determined using a rheological method involving oscillation amplitude sweep substantially as disclosed in T. G. Mezger, “Applied Rheology”, 1st Ed. 2015, Anton Paar GmbH, Austria, Chapter 15 (pp. 101-112), the content of which is incorporated herein by reference. Specifically, for the purpose of determining these values, a sample of the composite material disclosed herein is subjected to oscillation amplitude sweep at 25° C. and an angular frequency of 1.0 Hz (being approximately 6.3 Rad/s). The size of the sample being determined based on the probe used and according to manufacturer's instructions.

In some examples, the oscillation test is performed using Kinexus Pro+ rotational rheometer (plate-plate), using an upper smooth plate diameter of 25 mm, and a bottom coarse plate diameter of 60 mm. The oscillation tests can be performed at low strain range (as shown in exemplary and non-limiting Table 2) at 25° C.

The composite material of the present disclosure is characterized by at least a phase angle δ of between 8 and 20 when determined using an oscillation amplitude sweep (strain controlled) test at 25° C. and shear strain of 0.6% and frequency of 1.00 Hz. In some examples, the phase angle δ is between 8 to 20, when determined using an oscillation amplitude sweep (strain controlled) test at 25° C. at a shear strain of 0.6%, and frequency of 1.00 Hz. Notably, the oscillation test can be conducted at a start shear strain of 0.1% and end shear strain of 100%, yet, a distinguishing behavior is exhibited at a shear strain of above 0.5%, at any complex shear strain equal or above 0.6%, including equal or above 0.7%, equal or above 0.8%, equal or above 0.9%; and/or equal or above 1%.

Without being bound by theory, the phase angle δ of the composite material disclosed herein suggests its resemblance to other food stuff, having similar angles, such as, cheese and others having a phase angle δ of between 0 and 45.

In some further examples, the composite material has a phase angle δ of between 9 and 18, at times, between 8 and 15, at times, between 9 and 15.

The composite material can also be characterized by its bulk density. The bulk density is defined by the mass of the many seeds and mycelium holding the seeds together, in the composite material, divided by the total volume the seeds and mycelium occupy. The total volume includes seeds and mycelium volume, inter-seeds/mycelium void volume.

The bulk density (pA) can be determined by weighing the composite material sample placed within a container having a certain measurable volume of water and determining the volume of the sample by the change in the water level. The bulk density can then be calculated by dividing the weight by the volume. Since the bulk density is determined within water, it is sometimes referred to by the term “wet bulk density”.

Based on the above, the bulk density of the composite material was determined by equal or below 1 gr/cm³.

In some examples, the bulk density of the composite material disclosed herein is equal or below about 0.98 gr/cm³; at times equal or below about 0.96 gr/cm³; at times equal or below about 0.94 gr/cm³; at times equal or below about 0.92 gr/cm³; or even, at times, equal or below about 0.90 gr/cm³ or equal or below 0.89 gr/cm³.

For comparison, the bulk density of Tempeh-soybean is published to be between 0.909 to 1.079 g/cm³, and when compared with the composite material disclosed herein, the bulk density of the Tempeh product was always higher (Production and characterization of Tempeh from different sources of legume by Rhizopus oligosporus, Erkan et al, 2019).

The bulk density, being lower than that of the corresponding Tempeh (i.e. one prepared using the same type of seeds) was found to improve the mouthfeel, the tactile sensation and texture. The composite material disclosed herein thus results in an improved texture as compared to Tempeh, even when compared to Tempeh made with seeds other than soybean, resembling more the texture of mushroom than classical Tempeh. Both texture and mouthfeel of the disclosed edible composite material can be evaluated based on physical parameters obtained from dynamic rheological testing, steady shear testing, brittleness testing (the breakdown of food in the mouth), oscillation test that simulates chewing, as described already above, and specific rheological tests to define the obtained mouthfeel.

Thus, in addition to the already disclosed characterization of the viscoelastic properties (phase angle δ), the composite material disclosed herein can be characterized by its Young's Modulus of elasticity. Young's Modulus of elasticity can provide insight on the rigidity/stiffness of the edible composite. Specifically, the elastic modulus describes the rigidity of an edible composite through the ratio of stress (force/unit area over which it acts) to corresponding strain (increase in length/original length) along the linear portion of the stress-strain curve (i.e., E=stress/strain). In lay terms, this value estimates a material's stiffness in either tension or compression, and the higher the modulus the stiffer the material.

In accordance with some examples, the Young's Modulus is at least an order of magnitude (i.e. at least 10 times) greater than that of a reference seeds, when determined by a compression test including model—2519-107, probe—force transducer, capacity—5000 N, plate to plate, 7 cm diameter, speed—5 mm/min and end of test—80% compressive strain.

In the context of the present disclosure, the reference seeds are the seeds or combination of seeds from which the disclosed composite material (with which the comparison is made) is composed. For the comparison, the reference seeds need to be first soaked with water for at least 3 hours after which the liquid (e.g. water) is filtered out and the soaked seeds are autoclaved for 20 min, at 120° C. and high pressure (2 atm).

The Young's Modulus was determined using a compression test equipped with a probe force transducer, under conditions of probe—force transducer, capacity—5000 N, plate to plate, 7 cm diameter, speed—5 mm/min and end of test—80% compressive strain. The Young's Modulus was calculated manually using cursor.

The composite material can also be characterized by its aerial mycelium. Aerial mycelium is the portion of mycelium that grows upward or outward from the surface of the seeds. In accordance with some examples, the composite material disclosed herein is thus characterized by an aerial mycelium of less than 5% out of the total height of the composite material (height being the dimension perpendicular to the growing surface/bottom surface of the incubation container), this being determined by measuring the height of mycelium above the seeds.

In some examples, the composite material can be characterized by a protein to carbohydrate weight ratio. In some examples, the protein to carbohydrate weight ratio is at least 0.5.

The protein to carbohydrate ratio can be determined by calculating the total amount of protein and total amount of carbohydrates, using techniques known in the art, such as determination of nitrogen and protein levels using Kjeldahl method (AOAC 981.10) from which total amount of carbohydrates is calculated. Other constituents in the food are determined individually, summed, and subtracted from the total weight of the food, hence the total carbohydrate.

In some other examples, the composite material disclosed herein is characterized by its glycemic index (GI). In some examples, the composite material has a glycemic index (GI) that is at least 2 points below the GI of the seeds forming the composite material.

The composite material disclosed herein can also be characterized by its glycemic index (GI) which is lower from the GI of the seeds from which it is composed.

In the context of the present disclosure, the GI of the edible composite material is referred to as the composite GI, while the GI of the seeds without the mycelium, and without any treatment (As Is seeds) is referred to as the Reference GI.

When comparing the composite GI to the Reference GI it is made based on the same weight of the edible composite material and the As Is seeds.

The composite GI has been found to be at least 2 points lower than the Reference GI.

In this connection, it is noted that the GI of Tempeh is 15, while the GI of the soyabeans from which it is composed 16-18 [https://foodstruct.com/food/tempeh].

The GI can be determined clinically or theoretically.

The GI can be determined by any experiment acceptable in the art. In some case, the GI can be determined according to ISO 26642:2010 (determination of the glycemic index (GI) and recommendation for food classification).

In some examples, the GI is determined clinically by providing a measured portion of edible composite material, containing about 10-50 grams of carbohydrate to healthy subjects following an overnight fast. During the following two hours, blood samples are to be taken at between 15 to 30 minutes intervals. Based on this samples, a two-hour glycemic response curve is generated. The area under the curve (AUC) is calculated to reflect the total increase in blood glucose levels following intake of the edible composite. The GI rating (%) can be calculated by dividing the AUC of the edible composite by the AUC of a reference food (in most cases glucose or white bread) and multiplying it by 100.

With respect to the comparison to the GI of As Is seeds, their GI can be determined theoretically.

In some examples, a “theoretical measured GI” is one which is measured in accordance with Lin, Chii-Shy, et al. “Methodology for adding glycemic index to the National Health and Nutrition Examination Survey nutrient database.” Journal of the Academy of Nutrition and Dietetics 112.11 (2012): 1843-1851.

The edible composite not only has a GI lower than that of the seeds from which it is composed, it is also considered by be a food with low GI value. In this context, GI values below 55 are considered to be “low”, 56-69 are considered “medium” and 70 and above are considered “high”.

In some examples, the composite GI is determined theoretically based on the assumption that the edible composite material comprises 30% mycelium out of its total biomass, the rest 70% is seeds and other components such as water.

Taking lentils as the seeds within the edible composite material, and with the understanding that the GI of lentils is 32 [https://www.health.harvard.edu/diseases-and-conditions/glycemic-index-and-glycemic-load-for-100-foods], and the mean GI of mushrooms is about 10, the theoretical composite GI is calculation as follows:

GI=32*0.7+10*0.3=25.4

Which provide a composite GI which is 4 points below that of As Is lentils.

In some examples the composite GI is between about 2 to about 15 points lower than the GI of As Is seeds. In some other examples the composite GI is between about 3 to about 10 points lower, at times between 4 to 15 points lower, at times, between 5 to 10 points lower than that of the As Is seeds

Without being bound thereto, the advantages of utilizing the edible composite material in term of its beneficiary GI relates to the higher starch content in the As Is seeds, the formation of chitin in the edible composite (thus contributing to the lower GI). Additionally, mycelium is known of being rich in soluble fibers, i.e., mostly beta glucans, which are known for their ability to slow the digestion process and thus prolong the absorption period of simple sugars like glucose.

The edible composite material disclosed herein is obtainable or obtained by applying on fungal mycelium, and seeds substrate solid state fermentation (SSF) process.

Generally, fermentation can be divided into solid-state fermentation (SSF) and liquid-state fermentation (LSF) according to the water content in the system, and the principles of such systems are well known in the art.

Thus, in accordance with the present disclosure, the composite material is obtained or obtainable by a process comprising incubating fungal mycelium, from at least one non-toxic fungus, on a substrate comprising water soaked plant seeds, the incubation comprises solid-state fermentation (SSF) conditions, wherein the incubation of the moisturized plant seeds is at a density of less than about 0.3 gr/cm³ and for an incubation period of at least 55 hours, and preferably more than 60 hours or more than 70 hours.

In some examples, the pre-treatment comprises soaking of the seeds with the aqueous medium for at least 1 hour. In some cases, the soaking is for at least 2 hours, or for at least 3 hours. Sufficient soaking can be determined after the seeds are at least 50% saturated with water. Such seeds are referred to herein as water saturated seeds, even if not fully saturated with water or saline. Thus, the term “water saturated seeds” denotes any seeds being at least 50%, at times at least 60%, at times at least 70%, at times at least 80%, at times at least 90% or even 99% or 100% saturated with water or saline (preferably water). A person versed in the art would know how to determine level saturation of the seeds. Soaking can be achieved by submerging the seeds in the water/saline for a period of time.

The excess of liquid (the aqueous medium) is by filtering, pouring or decanting the liquid.

The resulting water saturated seeds provide between 40% to 80% humidity to the incubation environment.

In some examples, the pre-treatment of the water saturated seeds also includes sterilization/autoclaving under pressure.

The autoclaving under pressure is for a time sufficient to sterilize the seeds.

For example, pre-treatment can involve autoclaving of the water soaked seeds for 20 min, at 120° C. and the aforesaid high pressure (e.g. 2 atm).

It is noted that the above sterilization conditions may be considered extreme for the purpose of growing mycelium, however, is considered essential due to the long incubation period (of equal or above 55 hours as defined herein), which may result in contaminations. Thus, one means to avoid such contamination during long term incubation of the fungal mycelium is by the pre-treatment of the seeds including the moisturization and autoclaving.

The process disclosed herein takes place in a partially aerated closed system. The term “partially aerated closed system” is used herein to denote a container with a releasable cover that is configured to allow controlled aeration of the content of the container while preventing entrance of contaminants. While the cover allows access of air or oxygen, the level thereof is low, as further described below with respect to CO₂ levels.

Principles of the process disclosed herein are described below in more detail, each constituting a separate and independent embodiment of the present disclosure.

### Seeds Pre-Treatment:

Pre-treatment of the seeds is aimed at providing optimal moisture levels for the solid-state fermentation (SSF). The pre-treatment involves at least soaking of the seeds prior to incubation with the fungal material. The treatment also enables the breakage of carbohydrates and protein complexes of the seeds to make them available for the fungal biochemical processes.

In some examples, the pre-treatment comprises soaking the seeds in water or water containing mediums, such as saline to obtain the water saturated seeds. In one example, the pre-treatment comprises soaking in sterilized water. The purpose of the soaking is to increase humidity/moisture content, which is beneficiary for the SSF process.

In some cases, the pre-treatment comprises heating, e.g. cooking or autoclaving of the soaked seeds, inter alia, to reduce bioburden (sterilization), and reduces risks of contamination in the end product.

In some cases, pre-treatment comprises autoclaving under pressure. In some cases, pre-treatment is under a pressure greater than 1 atm, at times, at times, equal or above about 1.5 atm; at times equal or above about 2 atm, and at time equal or about 2.5 atm, at times, at a pressure between 1 atm and 3 atm, at times, between 1.5 atm and 3 atm; at times between 1.2 atm and 2.8 atm. For example, pretreatment can involve autoclaving (may be regarded also as cooking) for 20 min, at 120° C. and the aforesaid high pressure (e.g. 2 atm).

In some examples, pre-treatment may include also cracking of the seeds.

In some examples, pre-treatment may include de-hulling.

In some examples, pre-treatment does not include and does not require de-hulling.

### Incubation Period:

The present disclosure supports the understanding that incubation period is a critical parameter for providing the edible composite material disclosed herein. It has been found that incubation period should take several days, preferably, more than 55 hours, at times, more than 60 hours.

In some examples, incubation period comprises 3 or more days; at times, at least 4 days; at times, at least 5 days; at times, at least 6 days; at times, at least 7 days; at times, at least 8 days; at times, at least 9 days; at times, at least 10 days; at times, at least 11 days; at times, at least 12 days; at times, at least 13 days; at times, at least 14 days; at times, at least 15 days; at times, at least 16 days; at times, at least 17 days; at times, at least 18 days; at times, at least 19 days; at times, at least 20 days; at times, at least 21 days.

In some examples, the incubation period is for not more than 40 days; at times, not more than 35 days; at times, not more than 30 days; at times, not more than 29 days; at times, not more than 28 days; at times, not more than 27 days; at times, not more than 26 days; at times, not more than 25 days.

In some examples, the incubation period is within any range of the above defined lower and upper limits. In some examples, the incubation period is for a time duration between about 3 to about 25 days; at times, between about 4 to about 20 days; at times, between about 5 to about 15 days; at times, between about 7 to 21 days; at times, between about 7 to 14 days.

Without being bound by theory, it is believed that the defined incubation period, under controlled SSF conditions, allow for achieving a solid edible mass with mild fungus aroma and umami taste and stirred texture (which can be defined by modulus of elasticity). Yet, extended incubation periods, such as above 40 days, result in an inferior edible composite, with, inter alia, unpleasant odor.

Typically, incubation periods comprise two distinct sub-periods,
Trophophase—considered as the growth stage where most of the solid biomass develops. In the trophophase, the size, texture and density of the mass are developing, where at the end of this phase, the biomass arrives to its maximal size.
Idiophase—considered as the secondary growth stage where the size, density of the mycelium mass mostly remains unchanged.

The ability to control the transition between the phases allows achieving a desired density, size, texture, odor, and/or taste properties of the final product.

Holding the composite material in a tropophase may, for example, increase the size and density of the mycelium but would also limit its smell and taste features, i.e., the obtained edible composite would be tasteless and odorless. On the other hand, shortening the tropophase stage while elongating the idiophase stage would decrease the size and density of the final edible composite while strengthening the typically undesired “fungi-like” taste and odor.

Without wishing to be bound by theory, several factors induce the transition between the stages, such as the concentrations of oxygen and carbon-dioxide in the environment of the mycelium, the humidity, and/or duration of incubation. In other words, controlling such conditions would directly affect and allow the control of the final product in terms of look-feel-smell and taste properties.

### Incubation Temperature:

It has been found that, inter alia, the organoleptic properties of the edible composite material are affected by the incubation temperatures during the SSF process. The organoleptic properties are dictated by the density, width and branching of the hyphal network and the latter is affected by the incubation temperature. Specifically, it has been found that high temperatures lead to a mycelial heat stress which cause release of high amounts of stress metabolites and spoil the edible composite. Therefore, it has been concluded that the incubation temperature should not exceed about 32° C. In some examples, the incubation temperature should not exceed about 31° C.; at times, should not exceed about 30° C.; at times, should not exceed about 29° C.; at times, should not exceed about 28° C.; at times, should not exceed about 27° C.; at times, should not exceed about 26° C.; at times, should not exceed about 25° C. (±1° C.).

On the other hand, it was found that too low temperatures do not allow the hyphal network to sufficiently develop and form the required solid mass over the seeds. Therefore, in has been concluded that the incubation temperature should not be less than about 18° C. In some examples, the incubation temperature should not be less than about 19° C.; at times, should not be less than about 20° C.; at times, should not be less than about 21° C.; at times, should not be less than about 22° C.

In some examples, the incubation temperature is within the range of 18° C. to 32° C.; at times between 20° C. and 28° C.; at times between 20° C. and 32° C.; at times between 22° C. and 32° C.; at times between 20° C. and 28° C.; at times between 20° C. and 30° C.; at times between 20° C. and 28° C.; at times between 22° C. and 26° C.

### Humidity/Moisture Levels:

Growth of mycelial network may be affected by the moisture content. Low concentrations of water vapor in the air would inhibit the efficient growth of the network and would result in non-uniform mass where some regions would escalate to the idiophase stage where metabolites derogating the organoleptic properties are produced. High amounts of vapor could also weaken the stiffness the solid mass (due to increased amount of moisture).

In accordance with some examples, the SSF is conducted under conditions comprising at least 40% moisture; at times, at least about 45% moisture; at times at least about 50% moisture; at times at least about 55% moisture; at times, at least about 60% moisture; at times, at least about 65% moisture; at times, at least about 70%. The humidity is achieved, inter alia, from the water-soaked seeds. Yet, external moisture (e.g. sterilized water) may also be added during the incubation period.

In some examples, the SSF is conducted under conditions comprising at most about 80% moisture; at times at most about 75% moisture; at times, at most about 70%; at times at most about 65%; at times, at most about 60%; at times, at most about 55%.

In some examples, the SSF is conducted under controlled moisture conditions comprising moisture content in the range of about 40% to 80%.

### CO₂ Concentrations

The SSF process is conducted under controlled aeration. This can be determined by the ratio between CO₂ and oxygen concentration, being yet another parameter that can affect the manner by which mycelium grows over the seed material and subsequently the rheological properties of the composite material. The SSF process is conducted within a closed environment (chamber) to allow such controlled aeration. As shown in the non-limiting examples, high aeration of the chamber led to the formation of mycelium only at the top of the seeds/grains, i.e., a surface growth, high concentration of CO₂ with medium oxygen concentrations hindered the growth of the mycelium, where low oxygen concentration with high CO₂ concentrations completely terminated the mycelial growth.

In addition, the ratio and the concentrations of O₂ and CO₂ may play a role in the transition between the tropophase and idiophase stages and thus affects the texture, density, size, smell and taste features of the final product.

The level of CO₂ and/or O₂ within the growing chamber can be determined using dedicated CO₂ and/or O₂ sensors, which are known in the art. The level of CO₂ and O₂ are determined in ppm units or in % concentration units. In this connection, it is noted that normal outdoor CO₂ levels near ground level are typically 300-400 ppm or 0.03% to 0.04% in concentration and CO₂ levels indoors are typically higher, and can reach 1,000 ppm or 0.1%.

In some examples, level of CO₂ is determined at the surface of the composite material, without contacting the composite material, e.g. at a distance from the surface of the seeds of 0.5 cm-1 cm.

In some examples, an optimal level for the CO₂ at the surface of the composite material, within the growing chamber can be above 1,000 ppm, at times above 1,500 ppm, or even above 2,000 ppm or even up to 3,000 ppm. Yet, the level of CO₂ within the growing chamber would typically be less than 5,000 ppm, at times, less than 4,000 ppm or less than 3,000 ppm.

In some examples, the optimal level for the CO₂ within the growing chamber and at the surface of the composite material, can be between 1,000 ppm and 5,000 ppm; at times, between 1,000 ppm and 3,000 ppm; at times, between 1,000 ppm and 2,000 ppm; at times about 1,500 ppm±500 ppm.

It is to be appreciated that within the boundaries of the SSF process as defined herein, variations of the temperature and/or incubation time and/or CO₂ levels and/or moisture content may allow variations in the properties of the resulting composite material. For example, longer incubation may result in an increase in the fungal aroma of the edible composite.

In addition, the selection of the substrate, namely, the type of seeds (e.g. legumes with high protein/nitrogen content versus grains and thus less nitrogen arrest during growth period), the variety used, the rates between different seeds may affect the aroma, taste and color of the product.

The composite material is suitable for use as a food product per se, or as a food ingredient, thus having various applications in the food industry. For example, in can be consumed as is, e.g. after thermal treatment (cooking, frying etc) or freeze-drying, it can be combined with other, externally added food ingredients, such as flavors, binders and hydrocolloids.

As such, the present disclosure also provides food product comprising the composite material and at least one externally added food ingredient such as in plant-based or hybrid sausages and burgers.

As used herein, the forms “a”, “an” and “the” include singular as well as plural references unless the context clearly dictates otherwise. For example, the term “seeds” includes one or more seeds.

Further, as used herein, the term “comprising” is intended to mean that the composite include the recited elements, i.e. the mycelium and seeds, but not excluding other elements. The term “consisting essentially of” is used to define, for example, the composite includes the recited elements but exclude other elements that may have an essential significance on development of the properties of the resulting edible composite. “Consisting of” shall thus mean excluding more than trace elements of other elements. Embodiments defined by each of these transition terms are within the scope of this invention.

Further, all numerical values, e.g. when referring the amounts or ranges, are approximations which are varied (+) or (−) by up to 20%, at times by up to 10% of from the stated values. It is to be understood, even if not always explicitly stated that all numerical designations are preceded by the term “about”.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### DESCRIPTION OF NON-LIMITING EXAMPLES

### Example 1: Composite Material Comprising Fusarium proliferatum

(A) Preparation of Composite Material with Green Lentils Only

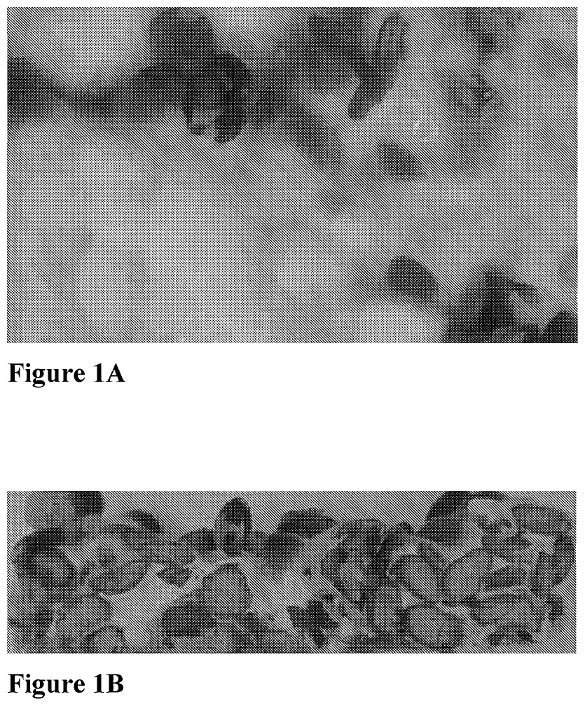

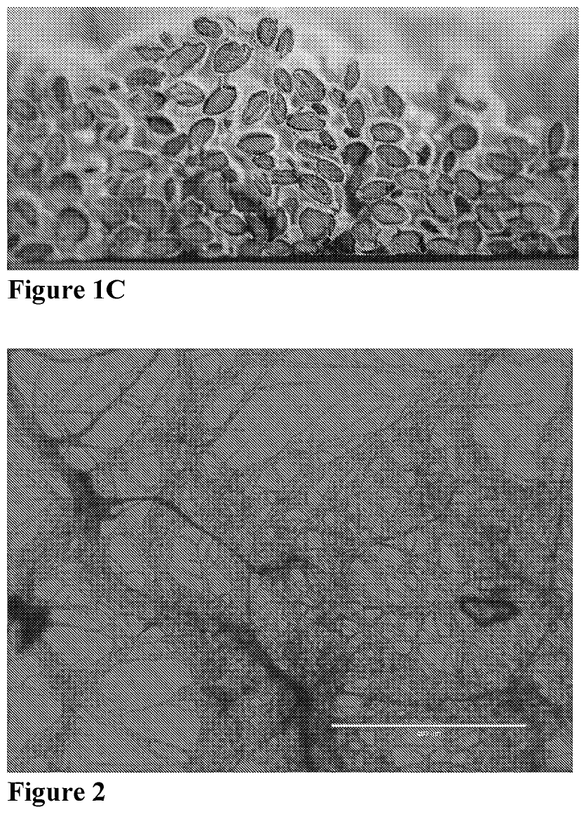

Seeds of green lentils (Lens culinaris, 100-150 g) were soaked with water for 3-16 hours. This soaking provided a high level of humidity to the seeds (within the range of 40-80%). Liquid was then removed, and the soaked lentils were then transferred to a heat-resistant glass container having a volume of 400-500 ml, and autoclaved for 20 min, at 120° C. and high pressure (2 atm). This cooking step was required for the availability of the lentils for the mycelia and removal of potential contamination. After the lentils cooled down, it was inoculated in a sterile environment upon discs from petri-dish with potato-dextrose-agar (PDA) with mycelia of Fusarium proliferatum grown for 6 days. The mycelia grew with lentils for a further period of 7 days, at 30° C. in dark environment, during which solid-state fermentation (SSF) took place. By the end of which the mycelia covered the entire mass of the lentils, as shown in FIGS. 1A-1C.

After sterilization, inoculation and SSF, the obtained edible fungi-based composite material had a mild mushroom aroma, and the lentil's mass was held together by the grown mycelium. The product had a good texture, as further discussed below. The final edible fungi-based bar was had a lentils mild taste.

The end-product was composed of both mycelia in white, and legumes and grains shown as the darker bodies within the product, as seen in the photographic images of the composite from top view (FIG. 1A), side view (FIG. 1B) and cross-sectional view (internal cut, FIG. 1C).

FIGS. 1A-1C further demonstrate the effects of humidity on the growth of the mycelium and the texture of the product. According to said figures, after 7 days of growth in the appropriate ranges of humidity (i.e., between about 40% to about 80%), the mycelium grew in the desired form and thickness and the final product had the desired texture.

The photographical images clearly show that the grown mycelium enclosed over all the lentils forming a mass in which the lentils are embedded.

FIG. 2 show that the mycelium in the edible composite was composed of a hyphal network.

(B) Green Lentils with or without Rice

Two end products (composite materials) were produced according to the method described above.
A composite material of mycelium of F. proliferatum and Lentils (the “Lentils-SSF” sample)
A composite material of mycelium of F. proliferatum and combination of Lentils (75%) and Rice (25%) (the “Lentils-Rice-SSF” sample).

Firstly, lentils and rice were soaked with water at room temperature. Excess liquid was then removed, and the soaked lentils and rice were then incubated with the mycelium. The first group included lentils and mycelium, which were incubated for 5 days and the second group included lentils and rice, with the mycelium, which were incubated for 6 days (one additional day was taken as it appeared that in the presence of rice, the growth of mycelia was slower. Incubation was carried out at a temperature of 28° C.

Control groups included sterilized grains (“Lentils” or combination of “Lentils-Rice”), each were autoclaved and cooled before mechanical measurements and analysis.

Characterization of the Composite Material with F. proliferatum as the Fungal Mycelium

### Rheological Properties

The following experiments were conducted with F. proliferatum as the fungal mycelium.

Young's modulus: Young's modulus was used to assess the mechanical properties of F. proliferatum carrying edible products and further measure the stiffness of the edible product after SSF.

After the prescribed incubation time, the samples were prepared for determining Young's modulus of elasticity. To this end, samples were prepared by cutting the edible composite of Example 1, as listed in Table 1 to the form of a circle with an average diameter of 15 mm and average height of 17.5 mm.

The acquired test samples were evaluated via a compression test by Instron Universal Testing Machine (Model 3345, Instron Corp. equipped with a 5000N load cell). The probe—force transducer, plate to plate, 7 cm diameter, speed—5 mm/min and end of test—80% compressive strain. The young's modulus was calculated manually using cursor.

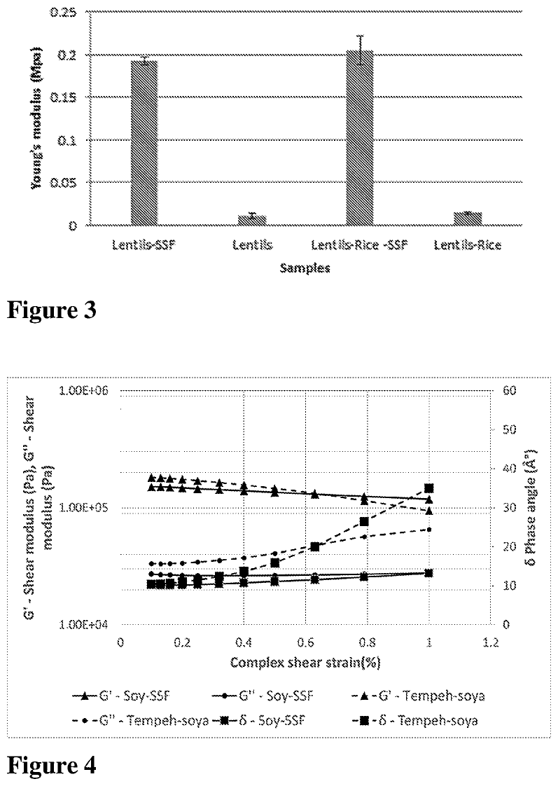

Table 1 and FIG. 3 summarize the Young's modulus for the test and control samples.

TABLE 1
Young's modulus of elasticity of F. proliferatum

| Sample | Modulus of elasticity |
|---|---|
| Lentils-F. proliferatum SSF | 0.193 ± 0.005 |
| Lentils | 0.011 ± 0.003 |
| Lentils-Rice-F. proliferatum SSF | 0.205 ± 0.017 |
| Lentils-Rice | 0.014 ± 0.001 |

As shown in Table 1, the control groups (included sterilized lentils, as discrete, and separate grains) had a Young's modulus value of ˜0.01 MPa, while the grain-fungi composite disclosed herein had a Young's modulus of ˜0.2 MPa after SSF treatment. This led to a conclusion that the mycelium holds the grains embedded within the mycelium mass and provides the resulting edible product with good stiffness making it suitable for use as an end product, such as a snack bar or a product that can be further manipulated by cooking or frying without it being disintegrated.

Oscillation test—The oscillation test for the different composite materials using F. proliferatum as the fungal mycelium was a measurement for product's microstructure stability. Generally, during oscillation amplitude frequency sweep (strain controlled) test at 25° C. and at start shear strain of 0.1%, end shear strain 100% and frequency of 1.00 Hz, which is an acceptable test in the food industry, the test sample is consecutively oscillated at various frequencies.

In the present examples, the oscillation tests were performed using Kinexus Pro+ rotational rheometer (plate-plate), using an upper smooth plate diameter of 25 mm, and a bottom coarse plate diameter of 60 mm. The oscillation tests were performed at low strain range (see Tables 2A-2B, for lentils based or soy-based composites, respectively) at 25° C.

Phase angle δ—The phase angle δ is a relative measurement of materials viscosity and elasticity characteristics. Visco-elastic materials demonstrating both characteristics exhibit a δ value of between 0° (ideally elastic behavior) and 90° (ideally viscous behavior). For viscoelastic material: 0°<δ<90° A solid like viscoelastic material exhibit a phase angle smaller than 45°, and liquid like viscoelastic material exhibits a phase angle greater than 45° (Handbook of Food Engineering edited by Dennis R. Heldman, Daryl B. Lund, p. 14). Hence the behavior of lentils-SSF is in the range of viscoelastic solid.

Table 2A presents average values of G′ (storage modulus, elastic portion), G″ (Loss modulus, viscous portion) and δ obtained from the oscillation test using 4 different samples of Lentils-F. proliferatum SSF after 5 days of SSF, while Table 2B shows similar parameters when measured on Soy-F. proliferatum-SSF.

TABLE 2A
Oscillation test results of lentils- F. proliferatum -SSF (n = 4)

| Complex | | | | | | |
|---|---|---|---|---|---|---|
| shear | G′ - Shear modulus | | G″ - Shear modulus | | δ Phase | |
| strain | (elastic component) (Pa) | | (viscous component) (Pa) | | angle (Â°) | |
| (%) | AVG | SD | AVG | SD | AVG | SD |
| 0.1 | 1.89E+05 | 2.25E+04 | 3.30E+04 | 4.60E+03 | 9.9 | 0.5 |
| 0.13 | 1.88E+05 | 2.30E+04 | 3.28E+04 | 4.45E+03 | 9.9 | 0.6 |
| 0.16 | 1.85E+05 | 2.33E+04 | 3.27E+04 | 4.35E+03 | 10 | 0.6 |
| 0.2 | 1.82E+05 | 2.34E+04 | 3.27E+04 | 4.27E+03 | 10.2 | 0.7 |
| 0.25 | 1.78E+05 | 2.34E+04 | 3.28E+04 | 4.21E+03 | 10.5 | 0.8 |
| 0.32 | 1.73E+05 | 2.33E+04 | 3.29E+04 | 4.15E+03 | 10.8 | 0.8 |
| 0.4 | 1.67E+05 | 2.32E+04 | 3.30E+04 | 4.11E+03 | 11.2 | 0.9 |
| 0.5 | 1.60E+05 | 2.29E+04 | 3.31E+04 | 4.08E+03 | 11.7 | 1 |
| 0.63 | 1.52E+05 | 2.26E+04 | 3.32E+04 | 4.09E+03 | 12.4 | 1.2 |
| 0.79 | 1.44E+05 | 2.22E+04 | 3.33E+04 | 4.09E+03 | 13.2 | 1.3 |
| 1 | 1.34E+05 | 2.17E+04 | 3.35E+04 | 4.03E+03 | 14.1 | 1.5 |

TABLE 2B
Oscillation test results of Soy- F. proliferatum SSF (n = 4)

| Complex | | | | | | |
|---|---|---|---|---|---|---|
| shear | G′ - Shear modulus | | G″ - Shear modulus | | δ Phase | |
| strain | (elastic component) (Pa) | | (viscous component) (Pa) | | angle (Â°) | |
| (%) | AVG | RSD | AVG | RSD | AVG | RSD |
| 0.1 | 1.51E+05 | 16.5 | 2.73E+04 | 12.0 | 10.3 | 4.6 |
| 0.13 | 1.51E+05 | 16.1 | 2.69E+04 | 12.2 | 10.2 | 3.9 |
| 0.16 | 1.50E+05 | 15.8 | 2.66E+04 | 12.2 | 10.1 | 3.7 |
| 0.2 | 1.48E+05 | 15.7 | 2.65E+04 | 12.4 | 10.2 | 3.5 |
| 0.25 | 1.46E+05 | 15.6 | 2.64E+04 | 12.6 | 10.3 | 3.3 |
| 0.32 | 1.43E+05 | 15.6 | 2.63E+04 | 12.7 | 10.5 | 3.0 |
| 0.4 | 1.39E+05 | 15.4 | 2.64E+04 | 12.9 | 10.7 | 2.8 |
| 0.5 | 1.35E+05 | 15.3 | 2.65E+04 | 13.2 | 11.1 | 2.6 |
| 0.63 | 1.30E+05 | 15.2 | 2.67E+04 | 13.4 | 11.6 | 2.5 |
| 0.79 | 1.25E+05 | 15.0 | 2.71E+04 | 13.7 | 12.3 | 2.3 |
| 1 | 1.18E+05 | 14.7 | 2.78E+04 | 14.3 | 13.2 | 1.9 |

Further, the measurements in Table 2A and Table 2B, showing that the lentils-F. proliferatum SSF and Soy-F. proliferatum-SSF can be considered visco-elastic solid, being similar to the results of other visco-elastic edible solids, such as cheese having an angle of 10-20 and this property is not dependent on the type of seeds used.

When comparing rheological properties, using the oscillation test, between Soy-SSF and Tempeh-soya, it was concluded that Fusarium fungus (Soy-SSF) instead of Rhizopus (Tempeh-soya) provided an improved stability and visco-elastic characteristic. In other words, using Fusarium generated a more stable and solid product compared to Tempeh.

Tables 3A-3B and FIG. 4 show that at low shear stress there was a similarity between lentils-F. proliferatum-SSF and tempeh made from soy; however at high shear stress lentils-F. proliferatum-SSF and soy-F. proliferatum-SSF remained stable and solid, while the tempeh-soya and tempeh-beans were less stable and presented semi-solid characteristic.

Tables 3A-3B present average values of G′ (storage modulus, elastic portion), G″ (Loss modulus, viscous portion) and δ obtained from the oscillation test using 4 different samples of Tempeh-soy (Table 3A) and Tempeh-black beans (Table 3B).

TABLE 3A
G′, G″ and δ of Tempeh- soybean (n = 4)

| Complex | | | | | | |
|---|---|---|---|---|---|---|
| shear | G′ - Shear modulus | | G″ - Shear modulus | | δ Phase | |
| strain | (elastic component) (Pa) | | (viscous component) (Pa) | | angle (A°) | |
| (%) | AVG | RSD | AVG | RSD | AVG | RSD |
| 0.1 | 1.82E+05 | 20.3 | 3.34E+04 | 19.0 | 10.4 | 1.5 |
| 0.13 | 1.80E+05 | 20.2 | 3.33E+04 | 18.7 | 10.5 | 3.2 |
| 0.16 | 1.78E+05 | 20.3 | 3.34E+04 | 18.1 | 10.7 | 5.6 |
| 0.2 | 1.75E+05 | 20.5 | 3.37E+04 | 17.2 | 11.0 | 7.5 |
| 0.25 | 1.70E+05 | 20.9 | 3.44E+04 | 16.1 | 11.5 | 8.4 |
| 0.32 | 1.64E+05 | 21.6 | 3.56E+04 | 14.0 | 12.4 | 8.0 |
| 0.4 | 1.56E+05 | 22.4 | 3.74E+04 | 13.1 | 13.7 | 6.7 |
| 0.5 | 1.46E+05 | 23.2 | 4.08E+04 | 13.5 | 15.9 | 5.7 |
| 0.63 | 1.33E+05 | 23.8 | 4.75E+04 | 15.4 | 20.0 | 6.1 |
| 0.79 | 1.15E+05 | 24.3 | 5.66E+04 | 18.5 | 26.5 | 6.9 |
| 1 | 9.43E+04 | 25.0 | 6.51E+04 | 20.1 | 35.0 | 8.3 |

TABLE 3B
G′, G″ and δ of Tempeh- black beans(n = 4)

| Complex | G′ - Shear modulus | | G″ - Shear modulus | | δ Phase | |
|---|---|---|---|---|---|---|
| shear | (elastic component) (Pa) | | (viscous component) (Pa) | | angle(Â°) | |
| strain(%) | AVG | RSD | AVG | RSD | AVG | RSD |
| 0.1 | 1.17E+05 | 12.6 | 3.96E+04 | 10.8 | 18.8 | 1.5 |
| 0.13 | 1.15E+05 | 13.9 | 3.99E+04 | 11.2 | 19.2 | 3.2 |
| 0.16 | 1.10E+05 | 15.2 | 4.02E+04 | 10.9 | 20.1 | 5.6 |
| 0.2 | 1.04E+05 | 16.4 | 4.09E+04 | 10.7 | 21.6 | 7.5 |
| 0.25 | 9.62E+04 | 17.4 | 4.18E+04 | 11.3 | 23.6 | 8.4 |
| 0.32 | 8.73E+04 | 18.1 | 4.26E+04 | 12.5 | 26.2 | 8.0 |
| 0.4 | 7.76E+04 | 18.4 | 4.33E+04 | 14.1 | 29.3 | 6.7 |
| 0.5 | 6.71E+04 | 18.0 | 4.39E+04 | 16.6 | 33.3 | 5.7 |
| 0.63 | 5.61E+04 | 18.6 | 4.38E+04 | 18.0 | 38.1 | 6.1 |
| 0.79 | 4.23E+04 | 13.8 | 4.27E+04 | 17.7 | 45.2 | 6.9 |
| 1 | 3.25E+04 | 24.2 | 3.96E+04 | 18.0 | 50.9 | 8.3 |

### Glycemic Index:

The edible composite obtained by the SSF process of Example 1 (lentils-SSF) exhibits yet another characterizing feature regarding the glycemic index (GI) thereof.

To calculate the GI a standard experimental method as described below will be conducted. The experiment includes measuring blood glucose levels after consumption of lentils-SSF and comparing thereof to blood glucose levels after consumption of lentils (without the mycelium). The experiment will be performed according to ISO 26642:2010 (determination of the glycemic index (GI) and recommendation for food classification).

Specifically, determination of GI index of a particular food or beverage can be achieved by providing a measured portion of food containing about 10-50 grams of carbohydrate to healthy subjects (e.g. 10) following an overnight fast. Over the next two hours, blood samples are taken at between 15 to 30 minutes intervals. These blood samples are used to produce a two-hour glycemic response curve. The area under the curve (AUC) is calculated to reflect the total increase in blood glucose levels following intake of food. The GI rating (%) is calculated by dividing the AUC of the test food by the AUC of the reference food (in most cases is glucose or white bread) and multiplying it by 100. GI values below 55 are considered to be “low”, 56-69 are considered “medium” and 70 and above are considered “high”. It is expected that the GI of the edible composite disclosed herein be lower than the GI of the seeds from which it is made. For example, in Lentils-SSF of Example 1, it is expected that the GI be at least 2 points lower than the GI of lentils, based on the following assumptions:

The theoretical estimated calculation of the GI of the Lentils-SSF of Example 1 is based on the estimation that the edible composite comprises 30% mycelium out of the total biomass of the composite, the rest 70% is seeds and other components such as water. Based on available literature, GI of lentils is around 32 (https://www.health.harvard.edu/diseases-and-conditions/glycemic-index-and-glycemic-load-for-100-foods), and the mean GI of mushrooms is about 10 (https://www.healthline.com/nutrition/mushrooms-good-for-diabetes#benefits). Therefore, the theoretical estimated calculation of GI of lentils-SSF (i.e. the edible composite of Example 1) would be as follows:

GI=32*0.7+10*0.3=25.4

In other words, the GI of the edible composite of Example 1 is estimated to be less than 26.

### Biochemical Properties

For biochemical analysis, edible composites were prepared according to Example 1.

Chitin: The biochemical composition of the edible composites was analyzed using Calcofluor-white (CFW) which is a fluorescent blue dye that bind to chitin. The analysis was performed using a florescence microscope with an EVOS FL Auto Cell Imaging System (Life Technologies), 357/44 nm Excitation: 447/60 nm Emission.

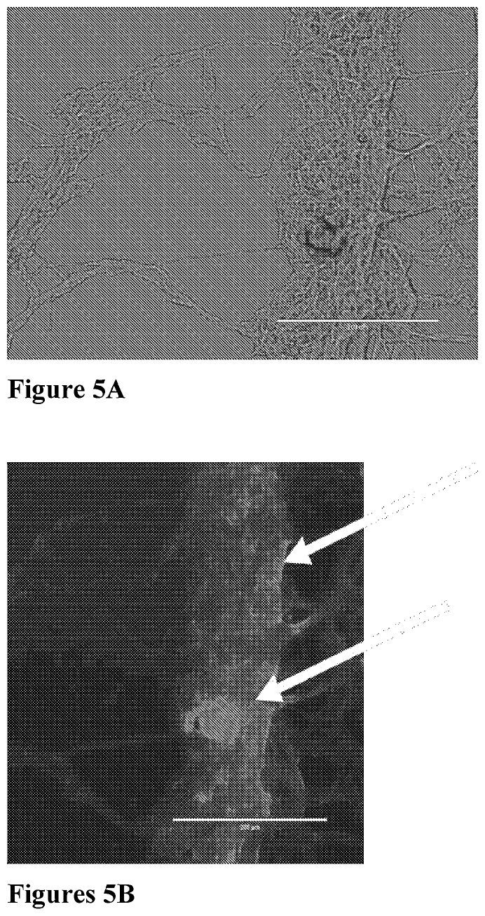

Microscopic images were taken for Lentils-SSF. Specifically, FIG. 5A is a microscope image of the mass holding the grains which shows to have the appearance of a network, confirming the formation of a mycelium hypha. The presence of chitin in the cell wall of the hypha of the same sample was visualized using Calcofluor-white staining, as shown in FIG. 5B (chitin marked with an arrow).

Protein and Carbohydrates: The protein and carbohydrate content of the edible composites were also determined and compared to their content in each of the lentils or grains which underwent similar pretreatment and sterilization processes but without inoculation thereof by the mycelium.

Specifically, the two edible composites produced according to Example 1 were analyzed using method SOP #20.WI.096 for fat and oils, AOAC 981.10 for protein, carbohydrates calculated values (subtracted fat and oils, protein, ash method AOAC 920.153 and humidity method AOAC 950.46), and energy calculated values. Table 4 provides the protein and carbohydrate content.

TABLE 4
Protein and carbohydrate content

| | | Lentils-SSF- | Lentils-SSF- | Lentils- | Lentils- |
|---|---|---|---|---|---|
| | Lentils | sample 1 | sample 2 | Rice | Rice-SSF |
| Energy | 395 | 397 | 402 | 404 | 408 |
| Kcal/100 gr | | | | | |
| Carbohy- | 72.73 | 58.06 | 54.76 | 78.00 | |
| drates | | | | | |
| % | | | | | |
| Protein % | 23.64 | 35.16 | 35.71 | 17.40 | |
| Fat % | 1.59 | 2.90 | | 2.20 | 3.33 |
| protein/ | 0.33 | 0.61 | 0.65 | 0.22 | |
| carb | | | | | |

Table 4 shows that the growth of the mycelia with the SSF process conditions increased the protein levels in lentils from 23% to about 35%. This significant increase was non-obvious as the amount of fungus initially added was neglectable and such a high increase in protein level, without increase in fungus odor or taste was unexpected.

Also, decreased levels of carbohydrates from about 72% to about 56%, were observed. This is probably due to the consumption of carbohydrate by the fungi as an energy source. The protein to carbohydrates ratio increased (from the original, before incubation, to after SSF process) from −0.3 to −0.6.

Amino acids: amino acid analysis was obtained by acid hydrolysis and analysis by HPLC (AOAC994.12).

It has been found that SSF of lentils or lentils with rice, increased the percentage of cysteic acid (3-sulfo-1-alanine), methionine sulfone, threonine and alanine, and decreased the levels of arginine amino acid as compared to the substrate without the mycelium. Also observed was an increase in percentages of all amino acids, except threonine compared to the mycelium grown on glucose.

Other changes were observed only in lentils-rice sample after SSF process, such as in valine and histidine levels which increased in comparison to the untreated (control) groups. In lentils-rice-SSF sample, γ-aminobutyric acid was detected, which was absent from the lentils-rice control group. The amino acids composition in the different samples is provided in Table 5.

TABLE 5
Amino acid composition

| | Lentils | Lentils-SSF | Lentils-Rice | Lentils-Rice-SSF |
|---|---|---|---|---|
| Cysteic acid | 0.1 | 0.15 | 0.1 | 0.13 |
| Aspartic acid | 1.08 | 1 | 0.9 | 0.72 |
| Methionine sulfon | 0.08 | 0.11 | 0.09 | 0.13 |
| Threonine | 0.34 | 0.43 | 0.27 | 0.35 |
| Serine | 0.43 | 0.44 | 0.35 | 0.37 |
| Glutamic acid | 1.65 | 1.45 | 1.39 | 1.1 |
| Gamma aminobutyric | ND | ND | ND | 0.13 |
| Proline | 0.51 | 0.49 | 0.34 | 0.39 |
| Glycine | 0.42 | 0.45 | 0.37 | 0.42 |
| Alanine | 0.45 | 0.53 | 0.39 | 0.62 |
| Valine | 0.51 | 0.57 | 0.43 | 0.53 |
| Isoleucine | 0.45 | 0.5 | 0.36 | 0.46 |
| Leucine | 0.79 | 0.77 | 0.64 | 0.71 |
| Tyrosine | 0.31 | 0.31 | 0.25 | 0.33 |
| Phenylalanine | 0.52 | 0.43 | 0.39 | 0.54 |
| Lysine | 0.73 | 0.7 | 0.53 | 0.44 |
| Histidine | 0.24 | 0.22 | 0.15 | 0.22 |
| Arginine | 0.86 | 0.59 | 0.61 | 0.45 |
| Total (%) | 9.46 | 9.13 | 7.56 | 8.05 |

Fatty acids: Fatty acid analysis was obtained by GC-FID.

It has been found, and as also shown in Table 6 below, that SSF of F. proliferatum with lentils or lentils-rice, increased the percentage of stearic acid in the final edible composite. Lentils-SSF resulted also in an increase in linolenic acid.

Interestingly, the utilization of SSF resulted in the presence of fatty acids which appear to absent in such amount from the grains. Specifically, palmitoleic acid, cis-10-heptadecenoic acid and erucic acid were found in the lentils-SSF sample while in the lentils-rice-SSF sample 11-eicosenoic acid and lignoceric acid were found.

The fatty acids composition is summarized in Table 6.

TABLE 6
Fatty Acid Composition

| | | Lentils- | Lentils- | Lentils-Rice- |
|---|---|---|---|---|
| | Lentils | SSF | Rice | SSF |
| Caprylic acid (C8:0) | | | 0.3 | |
| Myristic acid (C14:0) | 0.5 | | 0.7 | 0.7 |
| Pentadecanoic acid (C15:0) | | | | |
| Palmitic (C16:0) | 16.8 | 17.3 | 16.9 | 19.6 |
| Palmitoleic acid (C16:1) | | 0.8 | | 0.9 |
| cis-10-Heptadecenoic acid | | 0.7 | | |
| (C17:1) | | | | |
| Stearic (C18:0) | 2.8 | 4.7 | 2.7 | 4.6 |
| Oleic (C18:1n9c) | 25.3 | 22.3 | 23.8 | 21.2 |
| Linoleic (C18:2n6c) | 44.3 | 43.3 | 45.5 | 41.3 |
| Linolenic (C18:3n3) | 8.4 | 17.7 | 8.7 | 9.6 |
| Arachidic acid (C20:0) | 0.5 | 0.6 | 0.4 | 0.4 |
| cis-11-Eicosenoic acid | 0.7 | 0.6 | 0.7 | |
| (C20:1n9) | | | | |
| 11-Eicosenoic acid (C20:1n9) | | | | 0.4 |
| Behenic acid (C22:0) | 0.4 | 0.5 | 0.3 | 0.4 |
| Erucic acid (C22:1n9) | | 0.8 | | 0.6 |
| Lignoceric acid (24:0) | 0.4 | 0.6 | | 0.5 |

### B-Group Vitamins:

Presence B-vitamins were analyzed. The presence of vitamins B1 and B2 were examined using HPLC/FD. The presence of B9 was examined using LC/MS-MS.

SSF of lentils or lentils-rice altered the quantity of B-group vitamins. A decrease in B1 and increase in B2 vitamins was observed in comparison to the substrate which is either lentils or lentils with rice. Also, a decrease in vitamin B1 was observed as compared to the amounts of said vitamin in the fungus. For vitamin B9, levels of 5-metil-tetrahydrofolate and 5-formil-tetrahydrofolate components decreased significantly, hence the overall quantity of vitamin B9 decreased in the final edible composite. The composition of B-group vitamins acids in the final product is summarized in Table 7.

TABLE 7
vitamin B composition

| | | Lentils- | Lentils- | Lentils-Rice- |
|---|---|---|---|---|
| | Lentils | SSF | Rice | SSF |
| Vitamin B1 (Thiamine) | 1 | 0.3 | 0.9 | 0.3 |
| mg/kg | | | | |
| Vitamin B2 (Riboflavin) | 0.6 | 3.2 | 0.4 | 3.6 |
| mg/kg | | | | |
| Vitamin B9: | | | | |
| Folic acid μg/kg | 17 | 14 | 11 | 14 |
| 5-metil-tetrahydrofolate | 95 | 23 | 63 | Less than 10 |
| μg/kg | | | | μg/kg |
| 5-formil-tetrahydrofolate | 176 | 96 | 134 | 98 |
| μg/kg | | | | |
| Vitamin B9 total μg/kg | 288 | 133 | 208 | 112 |

### Example 2: Shitake Lentinula edodes Edible Composite

L. edodes mycelium was grown on Potato-Dextrose Agar (PDA-agar 1.5%) at 25° C. for 7 days. Then 2 discs from the petri-dish were added to 50 ml of PDB and grown therein for additional 5 days at 25° C. while shaking the samples at 60 rpm. Green lentils were pre-treated as described in Example 1, and the above-obtained mycelium was used to inoculate the lentils via SSF.

### Example 3: Oyster Mushroom Pleurotus ostreatus

P. ostreatus mycelium was grown on Glucose-peptone liquid media at 28° C. for 3 days without shaking. 50 gr of Quinoa were pre-treated as described in Example 1, and the above-obtained mycelium was used to inoculate the lentils via SSF. After 9 days at 28° C. the mycelium covered the Quinoa.

### Example 4: Fusarium Proliferatum with Various Seeds

Similar process that was described for green lentils (Example 1) was also tested for different types of:
1) Legumes: chickpeas, Beans, Peas, Lentils, Peanuts and Lupins.
2) Grains: wheat, oats, rice, corn (maize), barley, sorghum, rye, and millet.
3) Pseudocereal grains: Cereals, Pulses, Oilseeds, amaranth, buckwheat and quinoa

Different types of combination within and between the groups were tested.

In general, the final products obtained while using various types of seeds were similar to those of the green lentils. The election of seeds mostly affected the incubation period, texture, taste and odor of the final product. For instance, the utilization of only grains increased the incubation period to obtain the desired density and size of a final product, as compared to legume. Also, the resulting texture was a bit more fragile and easily disintegrated.

In the tested examples where rice was used as a substrate, the taste and smell of the final product was that of a fermented food.

The results thus suggested that the composite should preferably include at least some amount of legume.

Thus, the aroma and taste of a final product is mostly determined by three main factors: the substrate, the type of mycelium and the fermentations process (such as SSF). To obtain a final product having potent aromas and tastes, a suitable substrate having stronger smells and tastes should be utilized, such as pea, buckwheat, beans and lupin.

### Examples 5: Composite Material with Fusarium venenatum on Green Lentils

The visco-elastic behavior of Fusarium venenatum grown on green lentils (5 days of incubation, according to the procedure described above with Fusarium proliferatum) was determined in the same manner as described for F. proliferatum. Specifically, the delta (δ) phase angle was found to be between 8 and 15, when measured on an oscillation amplitude frequency sweep (strain controlled) test at 25° C. and at start shear strain of 0.1%, end shear strain 100% and frequency of 1.00 Hz. Therefore, the example with F. venenatum supports the finding that when using fungus having a slow growth rate, as defined herein, the resulting composite material has a unique and distinguishing visco-elastic behavior that is significantly different from that of Tempeh.

### Example 6: Comparative Examples

Composite Based on F. proliferatum with Other Inoculation Conditions and Methods—

### A—Alternative Conditions

The procedure described in Example 1 was repeated yet, under different temperature, humidity, and CO₂ conditions.

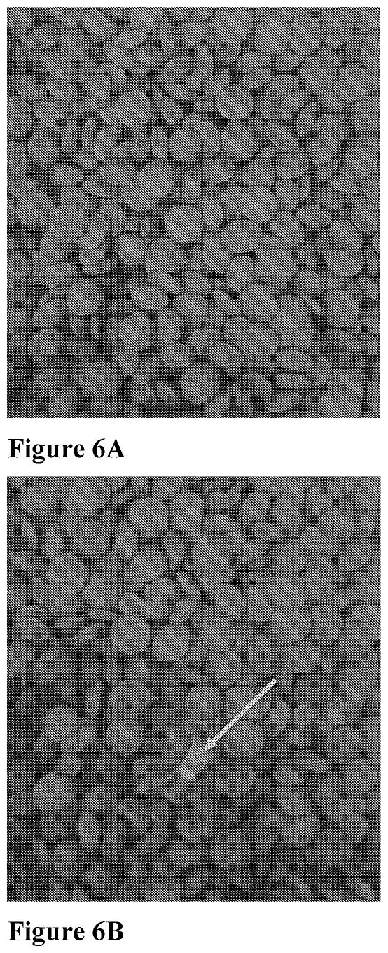

Firstly, the same procedure of Example 1 was repeated for Lentils-SSF, yet in comparison with low levels of moisture, of about 10%. All other growing parameters were the same (pre-treatment of seeds, CO₂, temperature, duration of incubation etc). FIGS. 6A-6B show the result of lentils grown for 7 days in an environment having low levels of moisture (about 10%). Specifically, the images show lack of sufficient growth (FIG. 6A) with only minimal mycelial growth (FIG. 6B—where the arrow is pointing on the mycelium).

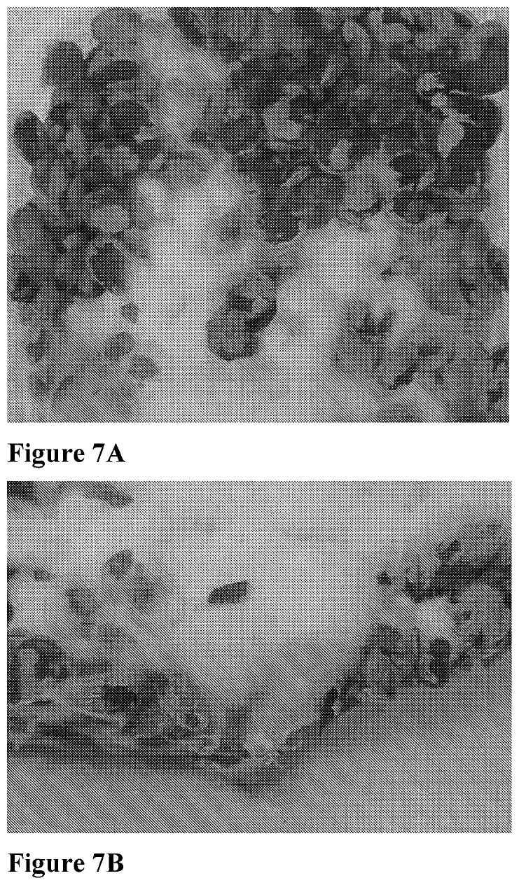

In a second set of comparative experiments, the amount of moisture was increased to about 85%. FIGS. 7A-7B are images of the edible composite grown for 7 days in an environment having such high levels of moisture. The images present formation of significant amounts of aerial hyphae at the top end of the composite, and low amounts of hypha at the bottom end of the composite (FIG. 7B). The overall texture of the acquired product was “mushy”.

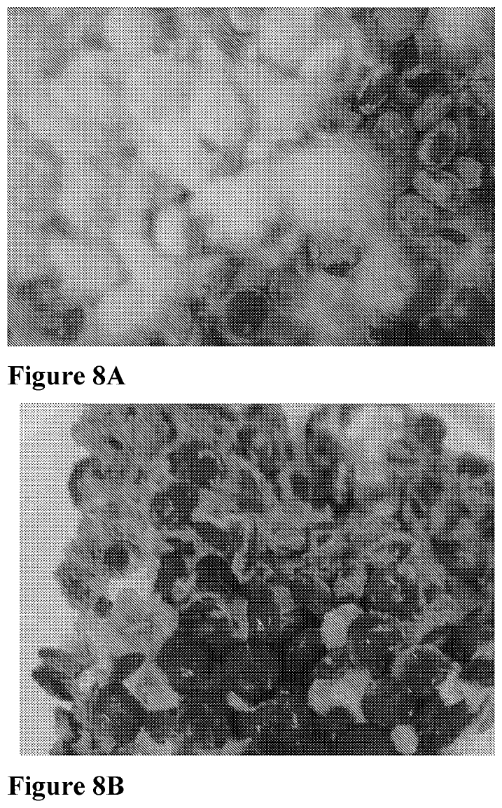

In yet a further set of comparative experiments, the parameter that was changed was the amount of CO₂. During the 7 days of incubation, the substrate and mycelium were highly aerated, to ensure low levels of CO₂. FIGS. 8A-8B are images of the composite grown for 7 days, after such excessive aeration (i.e. low CO₂ concentration). The end result is high content of aerial hypha at the top end of the composite (FIG. 8A) and low amounts of hypha at the bottom end of the composite (FIG. 8B).

To summarize, the results show that the humidity range and CO₂ levels are crucial for the complete growth of the mycelium scaffold over the seeds, and for providing an edible composite with the taste benefits of and rheological properties described above. Based on the experiments, it appears that excessive aeration (e.g. CO₂ levels below 400 ppm) or high CO₂ content (e.g. above 5,000 ppm) are not favorable.

### B—Alternative Methods

Two alternative methods were tested for inoculation of F. proliferatum mycelium on seeds.
(a) Discs from petri-dish with mycelium grown on Potato-Dextrose Agar (PDA-agar 1.5%) at 25° C.

The mycelium produced on PDA was then crushed and mixed with new PDA media or washed with sterile water and the liquid was then separated and used for inoculation.
(b) Mycelium grown in liquid Potato-Dextrose-Broth (PDB) with or without shaking.

The mycelium produced within the PDB was diluted with sterile water and the diluted liquid was then used for inoculation.

Using liquid media as obtained in (b) allowed faster colonization of the mycelium and reduced incubation period from 8 days for (a) to 6 days for (b).

### Comparative Example—Tempeh

To compare the edible composition disclosed herein with Tempeh, the procedure of preparing Tempeh is applied onto lentils and F. proliferatum, and vice-versa, the procedure of Example 1 is applied onto soybean and R. oligosporus.

Specifically,

(a) Tempeh Procedure on F. proliferatum (“Comparative A”)

Lentils were first soaked for 30 minutes in water, after which excess water was removed (drained) and the skinned legume was then cooked by boiling in an acidic soaking water at 100° C. for 90 minutes. After cooking the legume was dried and cooled and then inoculated with a suspension of F. proliferatum mycelium and tightly packed in sealed fermentation bags with ventilation at 31-37° C., for a growing period of up to 7 days inside the bags.

It has been found that after the growing period, the fungus did not sufficiently proliferate with only small growth of hyphae observed even after week from inoculation.

(b) Procedure of Example 1 on R. oligosporus (“Comparative B”)

The procedure of Example 1 was applied on soybean and spores of R. oligosporus.

Under the same conditions of Example 1, cooked and sterilized lentils seeds (treated as described above) were inoculated with R. oligosporus under a sterile environment, on discs from petri-dish with potato-dextrose-agar (PDA) with mycelia of R. oligosporus (previously grown for 6 days). The mycelia grew with lentils for a further period of 7 days, at 30° C. in dark environment, during which solid-state fermentation (SSF) took place.

The obtained fungi-based composite produced a highly dense and a large amount of aerial hyphae which composed 20-50% of total height of the product.

(c) F. proliferatum Grown on Soy in Procedure of Tempeh (“Comparative C”)

Tempeh procedure of Example 1 was applied on soybean and inoculated with F. proliferatum.

The fungi mycelium covered the soyabeans like the example with lentils, but the resulting fermentation process generated odor of spoilage and adverse taste. The product itself, Soy-SSF, was less firm than lentils. In oscillation test the Soy-SSF showed different characteristic than Tempeh-Soy, Table 4. In frequency sweep test lentils-SSF and Soy-SSF samples showed similar solidness to Tempeh-Soya and Tempeh-black beans.

### Example 7: Density and Bulk Density

The density of Lentils-F. proliferatum-SSF and of Tempeh were calculated by measuring the mass with electronic balance, and the volume by the external dimensions of the products at room temperature.

The Lentils-F. proliferatum-SSF was produced as described in Example 1. The Tempeh was purchased by commercial Israeli company by “Tempeh.il” (https://www.tempeh.co.il/). It was kept frozen upon arrival and thawed for experiments.

The density of Lentils-F. proliferatum-SSF was 0.45-0.8 gr/cm³ (the range depending on the type of seeds used). The density of tempeh, when determined under the same parameters, was 1-1.2 gr/cm³. Thus, in average, the density of Tempeh was higher by 40% than the Lentils-F. proliferatum-SSF. It appears that the difference in densities is a result of a higher degree of mycelium occupying the spaces between the seeds, or in other words, a higher mycelium to seeds ratio.

In addition, the bulk density of F. proliferatum on green lentils, F. venenatum on green lentils (0.91 gr/cm³, 0. 8 gr/cm³) and A. orayze on chickpea (0.88 gr/cm³) were measured by weighing sampled from each composite material within a container having a certain measurable volume of water and determining the volume of the sample by the change in the water level. The bulk density was calculated by dividing the weight by the volume. The determined bulk density for samples from F. proliferatum on green lentils, F. venenatum on green lentils, and orayze on chickpea were, respectively, 0.8 gr/cm³, 0.855 gr/cm³ (average of two samples) and 0.88 gr/cm³. The above results support the finding that when using fungus having a slow growth rate, as defined herein, the resulting composite material has a unique and distinguishing texture (exhibited by a low bulk density) that is significantly different from that of Tempeh.

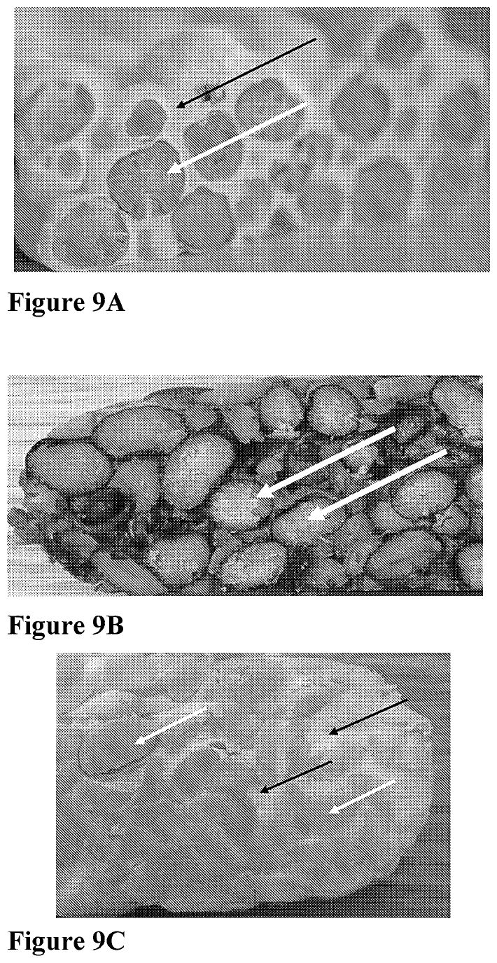

The difference in mycelium to seeds ratio can also be visualized, as shown as the white/bright filling between the seeds of the Lentils-F. proliferatum-SSF product shown in FIG. 9A in comparison to Tempeh-black turtle bean shown in FIG. 9B and Tempeh-soybean shown in FIG. 9C.

Specifically, as can be seen in FIG. 9A, the white mycelium (emphasized by the black arrow) surrounds the seeds (white arrow) and is much more pronounced in FIG. 9A than in the Tempeh products of FIGS. 9C and 9B.

1. A composite material comprising fungal mycelium and plant seeds, said fungal mycelium is of a non-toxic fungus, and is in a form of a filamentous mass occupying spaces between neighboring seeds, the seeds being essentially fixed in place and essentially evenly distributed within the mass,
wherein said composite material is visco-elastic, characterized by a delta (6) angle of between 8 and 20 when determined using an oscillation test at 25° C., and a complex shear strain of at least 0.6% and frequency of 1.00 Hz.

2. The composite material of claim 1, having a bulk density of less than 1 gr/cm³.

3. The composite material of claim 1 or 2, wherein said fungal mycelium is of a fungus having a growing rate that provides a bulk density of less than 1 gr/cm³, when said fungus mycelium is incubated for a period of at least three days at a temperature of about 26° C., with water saturated and autoclaved plant seeds placed on a growing medium at a seeds density of less than 0.3 gr/cm³.

4. The composite material of claim 1, wherein said fungal mycelium is of fungus being a member of the Ascomycota division of fungi.

5. The composite material of claim 1, wherein said fungal mycelium is of fungus being a member of the Ordariomycetes class of fungi.

6. The composite material of claim 1, wherein the fungal mycelium comprises a member of the Fusarium spp.

7. (canceled)

8. (canceled)

9. The composite material of claim 4, wherein said member of the Ascomycota species is selected from the group consisting of Aspergillus oryzae, Aspergillus Sojae, Aspergillus Luchuensis and Neurospora intermedia.

10. (canceled)

11. The composite material of claim 1, comprising edible fungal mycelium.

12. (canceled)

13. (canceled)

14. The composite material of claim 1, wherein said plant seeds comprises cereal grains, legumes, nuts and any combination of same.

15. (canceled)

16. (canceled)

17. (canceled)

18. (canceled)

19. The composite material of claim 1, having less than 5% aerial hypha out of the total height of said composite material.

20. The composite material of claim 1, having a Young's modulus that is at least an order of magnitude greater that of reference seeds, the reference seeds being the same plant seeds held by the fungal mycelium in the composite material after being water saturated and autoclaved, said Young's modulus being determined using a compression test, under the same conditions for testing the Young's modulus of the composite material.

21. The composite material of claim 1, comprising at least 50% legume, out of the total amount of plant seeds in said composite.

22. A process for producing a composite material, the process comprises incubating fungal mycelium, from at least one non-toxic fungus, on a substrate comprising water saturated plant seeds, said incubation comprises solid-state fermentation (SSF) conditions, wherein said incubation of the plant seeds is at a density of less than about 0.3 gr/cm³ and for at least 55 hours.

23. The process of claim 22, wherein at least one of the following conditions are fulfilled
said incubation is at a temperature of between 18° C. and 32° C.;
said water saturated plant seeds are obtained by soaking the seeds in a aqueous medium for a period of at least 1 hour and filtering said seeds;
said SSF conditions comprise incubation at a humidity of between about 40% and about 80%
said incubation is within a closed environment permitting controlled access of oxygen; or
said SSF conditions comprise incubation under CO₂ environment comprising between about 1,000 ppm and about 3,000 ppm CO₂ when measured at a distance of not more than 1 cm from the surface of the composite material.

24. (canceled)

25. (canceled)

26. (canceled)

27. The process of claim 22, comprising autoclaving said water saturated plant seeds prior to incubation with said fungal mycelium.

28. The process of claim 22, wherein said fungal mycelium is of a fungus having a growing rate that provides a bulk density of less than 1 gr/cm³, when said fungus mycelium is incubated for a period of at least three days at a temperature of about 26° C., with moisture and autoclaved plant seeds placed on a growing medium at a seeds density of less than 0.3 gr/cm³.

29. (canceled)

30. The process of claim 22, wherein said fungal mycelium is of fungus being a member of the Ascomycota division of fungi.

31. The process of claim 22, wherein said fungal mycelium is of fungus being a member of the Ordariomycetes class of fungi.

32. The process of claim 22, wherein the fungal mycelium comprises a member of the Fusarium spp.

33. (canceled)

34. (canceled)

35. (canceled)

36. (canceled)

37. (canceled)

38. A food product comprising the composite material of claim 1 and at least one externally added food ingredient.
